(19) United States
(12) Patent Application Publication
(10) Pub. No.: US 2025/0335343 A1
(43) Pub. Date: Oct. 30, 2025

(54) SYSTEMS, DEVICES, AND METHODS FOR DEPOT MANAGEMENT

(71) Applicant: AeroVironment, Inc., Arlington, VA (US)

(72) Inventors: Pradiptya Ghosh, San Jose, CA (US); William Scott Bowman, Melbourne, FL (US)

(21) Appl. No.: 19/195,413

(22) Filed: Apr. 30, 2025

Related U.S. Application Data
(60) Provisional application No. 63/640,670, filed on Apr. 30, 2024.

(51) Int. Cl. G06F 11/3698; G06F 8/65; G06F 8/77

(52) U.S. Cl. CPC G06F 11/3698; G06F 8/65; G06F 8/77

(57) ABSTRACT

Systems, devices, and methods including a vendors ecosystem configured to provide a software component; an account portal configured to: determine existence of any issues based on whether the provided software component passes a laboratory field test; report issues to the at least one external software developer; receive an updated software component from the at least one external software developer fixing the reported issues; and release the software component if no issues are found indicated that the test was passed; and an end user operation system configured to: determine an existence of any issues based on whether the released software component passes a frontline field test to certify the software component; report any issues from the frontline field test to the external software developer; and deploy the certified software component on one or more devices if no issues from the frontline field test are found.

### CROSS-REFERENCE TO RELATED APPLICATION

This application claims the priority benefit of U.S. Provisional Patent Application Ser. No. 63/640,670 filed Apr. 30, 2024, incorporated herein by reference in its entirety.

### TECHNICAL FIELD

Embodiments relate generally to software updates, and more particularly to management, testing, and deployment of software updates.

### BACKGROUND

Software is essential to the operations of a modern organization including governments, businesses, and similar entities. Software is a key component of the organization system, enabling efficient operations and improving the accuracy and effectiveness of decisions and actions. Accordingly, it is important for organizations to rapidly develop, deliver, and adapt resilient software to achieve improved outcomes.

### SUMMARY

A system embodiment as disclosed may include: a vendor ecosystem including at least one external software developer; an account portal; an end user operation system; and where the vendor ecosystem may be configured to provide a software component; where the account portal may be configured to: determine existence of any issues based on whether the provided software component passes a laboratory field test; report issues to the external software developer; and receive an updated software component from the external software developer fixing the reported issues; release the software component if no issues are found indicated that the test was passed; where end user operation system may be configured to: determine existence of any issues based on whether the released software component passes a frontline field test to certify the software component; report issues to the external software developer; and deploy the certified software component on devices if no issues are found; where the system may be configured to iterate the issue report, the laboratory field test, and the frontline field test for the devices in use.

In one embodiment, the software component may include at least one of software or software update. In one embodiment, the account portal may include a software and update request system configured to request the software component to the at least one external software developer in the vendor ecosystem. In one embodiment, the issues found during the laboratory field test, the frontline field test, and mission deployment may be configured to be reported to the developer via the software and update request system of the account portal. In one embodiment, the account portal may include a software factory configured to receive the software component from the vendor ecosystem and where the software factory may comprise: a laboratory field test module configured to perform the laboratory field test, and a software release module configured to release the test passed software component to the end user operation system based on a predetermined schedule.

In one embodiment, each of the laboratory field test and the frontline field test may be configured to be performed using at least one of simulation or a test device. In one embodiment, the end user operation system includes a software depot comprising: a frontline field test module configured to perform the frontline field test, and a mission deployment module configured to deploy the certified software component on the devices for mission deployment. In one embodiment, the end user operation system may further include a server in communication with the account portal and the software depot; and where the server includes at least one of a cloud server or an on-premises server. In one embodiment, the software depot further includes a simulation module to train users of the devices.

A method embodiment may include: receiving, by an account portal, a software component from at least one external software developer in a vendor ecosystem; determining, by the account portal, whether the provided software component passes a laboratory field test; reporting, by the account portal, issues found in the laboratory field test to the developer; releasing, by the account portal, the test passed software component to an end user operation system, if no issues are found; determining, by the end user operation system, whether the released software component passes a frontline field test to certify the software component; reporting, by the end user operation system, issues found in the frontline field test to the developer; and deploying, by the end user operation system, the certified software component on devices if no issues are found.

A method embodiment may also be where the step for receiving software component includes receiving an updated software component fixing the issues from the developer. A method embodiment may also be where the method iterates the steps for receiving software component, the laboratory field test, reporting issues found in the laboratory field test, releasing, the frontline field test, reporting issues found in the frontline field test, and deploying, to maintain the devices in use. In one embodiment, the step for reporting the issues found during the laboratory field test, the frontline field test, and mission deployment may be performed via a software and update request system of the account portal. In one embodiment, the step for releasing the test passed software component may be performed based on a schedule predetermined by an operator of the account portal. In one embodiment, each of the laboratory field test and the frontline field test may be performed using at least one of simulation or a test device.

Another method embodiment may include: performing, by an account portal, a laboratory field test on a new untested update using one or more test vehicles; generating, by the account portal, a report of any bugs discovered during the laboratory field test verifying the functionality of the new untested update; verifying and certifying, by the account portal, the new untested update as a lab tested update if no bugs are discovered during verifying the functionality of the new untested update; transmitting, by the account portal, the lab tested update to a software depot; performing, by the software depot, a frontline field test on the lab tested update using one or more test vehicles; generating, by the software depot, a report of any bugs discovered during the frontline field test verifying the functionality of the installed lab tested update; verifying, by the software depot, the lab tested update as ready for field deployment if no bugs are discovered during the frontline field test; and loading the verified lab tested software on devices and to be ready for deployment.

In one embodiment, the step for performing a laboratory field test may include: installing the new untested update on the one or more test vehicles; and verifying the functionality of the new untested update on the one or more test vehicles. In one embodiment, the step for performing a frontline field test may include: installing the lab tested update on one or more test vehicles via the software depot; and verifying functionality of the installed lab tested update on the one or more test vehicles. In one embodiment, the step for sending the lab tested update may be performed based on a schedule predetermined by an operator of the account portal and the method may iterate the steps for performing a laboratory field test, generating a report of any bugs discovered during the laboratory field test, verifying and certifying as a lab tested update, sending the lab tested update, performing a frontline field test, generating a report of any bugs discovered during the frontline field test, verifying and certifying the lab tested update, and deploying the verified lab tested software, to maintain the devices in use.

Another system embodiment may include: a vendor ecosystem including at least one external software developer and configured to provide software component; an account portal configured to determine if the provided software component passes a laboratory field test, where the account portal may be configured to report issues to the developer and to release the test passed software component if no issues are found; an end user operation system configured to determine if the released software component passes a frontline field test to certify the software component, where the end user operation system may be configured to report issues to the developer and to deploy the certified software component on devices if no issues are found, where the account portal may be configured to receive an updated software component fixing the issues from the developer, and where the system may be configured to iterate the issue report, the laboratory field test, and the frontline field test for the devices in use.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a depot management system for digital transformation at an organization, according to one embodiment;

FIG. 2 depicts a schematic diagram of simulation or test operation and actual deployment managed by a depot management system, according to one embodiment;

FIG. 3 depict a depot management system including a frontline software distribution and verification depot, according to one embodiment;

FIG. 4 depict a depot management method for a frontline software distribution and verification depot, according to one embodiment;

FIG. 5 illustrates an example top-level functional block diagram of a computing device embodiment;

FIG. 6 shows a high-level block diagram and process of a computing system for implementing an embodiment of the system and process;

FIG. 7 shows a block diagram and process of an exemplary system in which an embodiment may be implemented; and

FIG. 8 depicts a cloud computing environment for implementing an embodiment of the system and process disclosed herein.

### DETAILED DESCRIPTION

The present system and method enable all processes related to software development, update, and management of devices to be handled by a single system. The present system and method allow for testing and certification of software updates to certify software and updated systems for devices (e.g., a fleet) rapidly. This prevents post-production software update and certification from becoming slow and expensive.

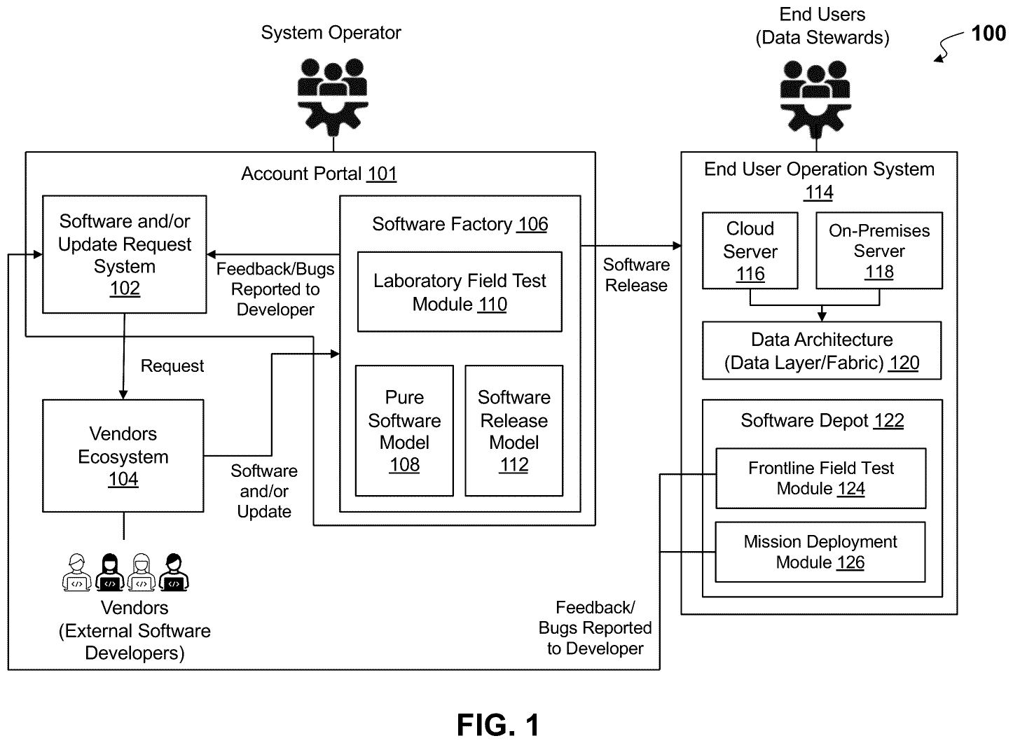

FIG. 1 depicts a depot management system 100 for digital transformation at an organization (e.g., company, government organization, etc.) to develop, update, and manage software for organization devices. The disclosed embodiment decouples a certifying authority of the system from those performing the certification. Hence, the system 100 is configured to enable certification of a system with post-production software updates to be executed at the edge and distributed, while also facilitating rapid deployment of those updates. Referring to FIG. 1, the depot management system 100 may be configured to perform software development, update, and management processes for the systems of devices used for various purposes, including business operations, tactical and strategic operations, logistics and supply chain management, manufacturing and production, real-time monitoring and coordination, etc. The depot management system 100 may include an account portal 101, a vendors ecosystem 104, and an end user operation system 114.

The account portal 101 may include a software and/or update request system 102 and a software factory 106 that each communicate with each vendors ecosystem 104 and the end user operation system 114. The software and/or update request system 102 may define software needs and/or update needs to operate systems of devices used by an organization and request the vendors ecosystem 104 to develop and/or update the software based on the needs. Upon request, the vendors in the vendor ecosystem 104 may develop and/or update software components (e.g., at least one of a software and a software update) and transmit the developed software component to the software factory 106.

The software factory 106 may test the software and if there are issues detected and/or bugs found, the software factory may report the detected issue and/or bug to vendors (e.g., external software developers) in the vendors ecosystem 104 via the software and/or update request system 102. The software factory 106 may also be configured to manage the release of the software and/or updates to the end user operation system 114.

Once the end user operation system 114 receives the software and/or updates, it may also test the software to certify the software and may report feedback and/or bugs to the vendors through the software and/or update request system 102. Then, the end user operation system 114 may deploy the certified software on their systems of devices for actual missions.

Upon receiving update requests, such as feedback and/or bug reports, the external software developers in the vendors ecosystem 104 may provide software components (e.g., the software update) to improve the software and/or correct bugs and transmit the update to the end user operation system 114 via the software factory 106. The transmitted update may be tested using simulation in the software factory 106 and then using a test device in the end user operation system 114. If the update is certified through the tests, the end user operation system 114 may deploy the updated software on their device systems. The end user operation system 114 may also keep monitoring the updated software and report feedback and/or bugs to the vendors, thereby enabling continuous management of the software.

Accordingly, while the software is in operation, the software development, update, and management processes, including planning, coding, building, and testing, may be continuously iterated in an agile manner under the depot management system 100. That is, software and updates for devices may be rapidly developed, delivered, and adapted to the device systems, allowing the systems to achieve improved outcomes.

Specifically, the software and update request system 102 of the account portal 101 may be configured to define software needs and/or update needs to operate systems of the organization and request the vendors ecosystem 104 to develop and/or update the software based on the needs.

In some embodiments, in the software planning phase, a single order to develop new software may be requested from the software and/or update request system 102 to the vendors ecosystem 104, and software developers of the vendors ecosystem 104 may develop new software based on this request. In the software execution phase, more than one order may be requested from the software and/or update request system 102 to the vendors ecosystem 104 based on the feedback and/or bugs reported by the end user operation system 114.

For example, there may be one Purchase Order Requests (PoRs) in a Software Acquisition Pathway (SWP) planning phase. There may be five PoRs in SWP execution phase. All PoRs through the depot management system 100 may be implemented as agile software development. SWP may be the acquisition method at a governmental entity/department (e.g., DoD) where it is initiating and making regular SW drop-ins a norm and SW is just sold by itself. The disclosed depot management system 100 addresses the key challenge of updating systems with regular software drop and needing the system to be operationally certified.

The software developers in the vendors ecosystem 104 may be configured to develop and/or update software upon request and transmit the software to the software factory 106 through the account portal 101. The vendors ecosystem 104 may include multiple vendors, such as software developers, software service providers, similar companies or individuals, and may be managed by the organization. For example, fifty or more vendors may be in a Modular Open Systems Approach (MOSA) ecosystem to provide software to the software factory 106. The disclosed embodiments provide a system that is independent of and does not significantly affect the overall MOSA process. MOSA may be related to avoiding vendor locking and enabling rapid subsystem update, which may need the software factory 106. That helps in achieving the key intent of MOSA, which is to reduce vendor lock-in and make rapid subsystem updates easier. The disclosed depot management system 100 reduces the cost of subsystem update and integration at the software level. Accordingly, the disclosed embodiments provide a system that is independent or not directly dependent on, nor hindering, MOSA readiness.

The software factory 106 may be configured to acquire the developed software and/or software update from the vendors ecosystem 104 and may include a pure software model 108, a laboratory field test module 110, and a software release model 112. The pure software model 108 may be configured to store the acquired software and/or software update. The acquired software may be for the systems of devices, such as a fleet, and may include Apps, Models, software platforms, and Infrastructure as code (e.g., OS and API). The laboratory field test module 110 may be configured to test the acquired software using simulation and/or a test device. If there are issues detected and/or bugs found, it may report it to software developers in the vendors ecosystem 104 via the software and/or update request system 102. Then, the software developers in the vendors ecosystem 104 may provide a set of one or more updates in response to the reported issues and/or bugs.

If the acquired software has no issues, it may be released from the software factory 106 to the end user operation system 114 via the software release model 112. The software release model 112 may manage the frequency or schedule of the software and update release. Software (SW) releases may be performed on a regular basis. The release of the test passed software component may be performed based on a schedule predetermined by an operator of the account portal 101. In some embodiments, the SW release may be accelerated from yearly to quarterly. In some embodiments, two-week sprints may be used as a part of the agile framework. Since the cost of certification of the system is high, and the SW test and stabilization typically takes approximately 4-6 weeks for SW enabled hardware systems, managing the frequency or schedule of the software and update release by the depot management system 100 helps mitigate and reduce the certification challenge. Decision-making is empowered at the team level while setting conditions for integration.

The depot management system 100 may be configured to provide a centralized management, optimized storage, and efficient deployment. That is, the disclosed embodiments are configured to reduce disk space usage, execute faster download times, and simplify maintenance and upgrades, along with easier organization of software orders and license keys. The depot management system 100 may further be configured to act as a central repository for software orders, reducing redundancy by sharing common files across multiple orders where this shared content approach saves significant disk space, especially when dealing with large software installations.

The end user operation system 114 may include a server, including at least one of a cloud server 116 and an on-premises server 118, a data architecture 120, and a software depot 122. The end users of the operation system 114 may be data stewards who may have access to the servers 116, 118, the data architecture 120, and the software depot 122. For example, end users may be seventy or more data stewards. The end user operation system 114 may use a cloud environment and/or on-premises servers 116, 118 in communication with the data architecture 120 (e.g., a data layer/fabric) and the software depot 122.

The servers 116, 118 may be configured to receive the lab tested software and/or updates released from the software factory 106 of the account portal 101. The lab tested software and/or updates may be stored in the data architecture 120 and transmitted to the software depot 122. The software depot 122 may include a frontline field test module 124 configured to certify and/or verify the software and a mission deployment module 126 configured to deploy the software and/or update on devices for actual mission.

The frontline field test module 124 may test the lab tested software and/or update using simulation and/or a test device to certify the software and may report feedback and/or bugs to the software developers in the vendors ecosystem 104 through the software and update request system 102. The certification may be an automated test procedure that may be executed/run at the edge. In other words, the depot management system may ship SW and certification test procedures to be executed on the edge. If the system passes test procedure on the edge, it may obtain the result and send the results to a certifying authority for record keeping.

If there are no issues found, the certified software and/or update may be deployed on devices for actual mission through the mission deployment module 126. Additional feedback and/or bugs found during the actual operations may also be reported to the software developers in the vendors ecosystem 104 through the software and/or update request system 102. With this incorporated process through the depot management system 100, software may be rapidly developed, delivered, and adapted to achieve improved outcomes.

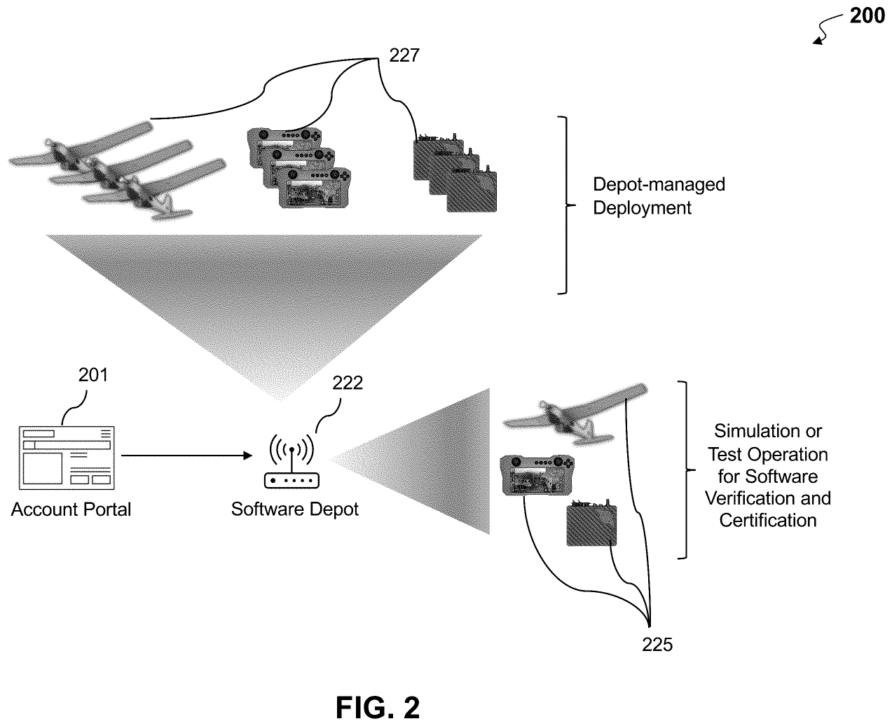

FIG. 2 depicts a schematic diagram of simulation/test operation and actual deployment managed by a depot management system 200, according to one embodiment. To operate the systems effectively and achieve improved outcomes, organizations (e.g., company, government organization, etc.) may need to update the software for the systems of their devices (e.g., a fleet) on a regular basis (e.g., six-month basis). They may also need to certify software and updated systems for devices (e.g., a fleet) rapidly. In addition, the organizations may need to train end users (e.g., employees, warfighters) on the updated systems. The disclosed depot management system 200 may allow all these actions to be managed by a single system.

The depot management system 200 may act as an IT department of the organization, which manages all processes including software/update development requests, software/update verification and certification, and actual deployment of software/update. The data stewards in the depot management system 100 shown in FIG. 1 may be the IT manager for the end user organization. The data stewards may have a depot manager. The data steward may enable all processes including software/update development requests, software/update verification and certification, and actual deployment of software/updates for all the end user in a way similar to how an IT manager manages patch updates for all the end user laptops across an organization. The end user organization may have a pull or push policy for SW updates.

Referring to FIG. 2, the software depot 222 of the depot management system 200 may acquire software and/or software updates for their devices from an account portal 201. Before deploying the software and/or update on their devices, the software depot 222 may perform a test operation and/or a simulation to verify and certify the software. When performing the test operation, a test device 225 (e.g., test vehicle) may be utilized. In one embodiment, the test vehicles may be aerial vehicles (AVs), unmanned aerial vehicles (UAVs), ground control stations (GCS), and the like. In addition, the software depot 222 may perform simulations that run on a test software (e.g., a frontline field test software). If any issues or bugs are found during the test operation and/or simulation, the feedback and/or bugs may be reported to the software developers via the account portal 201 to correct the bugs and improve the software. If there are no issues and bugs, the verified and certified software may be deployed on the systems of devices 227 (e.g., fleet) for actual missions.

Accordingly, the certification of the software and/or updates may be performed on edge level simulation, and the certificate management may be handled by the depot management system 200. In some embodiments, the simulation on the frontline field test software performed under the software depot 222 and simulation on the laboratory field test software may be the same. In some embodiments, there may be some extra test scripts running on the software depot 222 to avoid issues with software update if the actual systems of devices (e.g., fleet) are configured slightly out of sync with a test vehicle for field test. In one embodiment, in the depot management system 200, the software for devices (e.g., plane and/or other aircraft software) may be updated at the software depot 222 leveraging an account portal and a depot management hardware, e.g., a network of real-time data analytics and processing platform software and a ground control system (GCS).

In some embodiments, the software depot 222 of the depot management system 200 may include Safety Integrity Level (SIL) simulations that may be run on a real-time data analytics and processing platform software array and may be configured to generate data automatically that data stewards may use to verify and certify updated systems. Accordingly, the depot management system 200 may validate and certify software and/or update configuration(s) and pushes software and/or updates to the devices (e.g., fleet) on the predetermined schedule of the organization.

In some embodiments, the software depot 222 of the depot management system 200 may use real-time data analytics and processing platform based simulations to train warfighters and train them for mission. For government use, updates in the depot management system may be managed by a maintenance depot. The management depot may include an asset owner or delegate at the governmental entity (e.g., Department of Defense) depot.

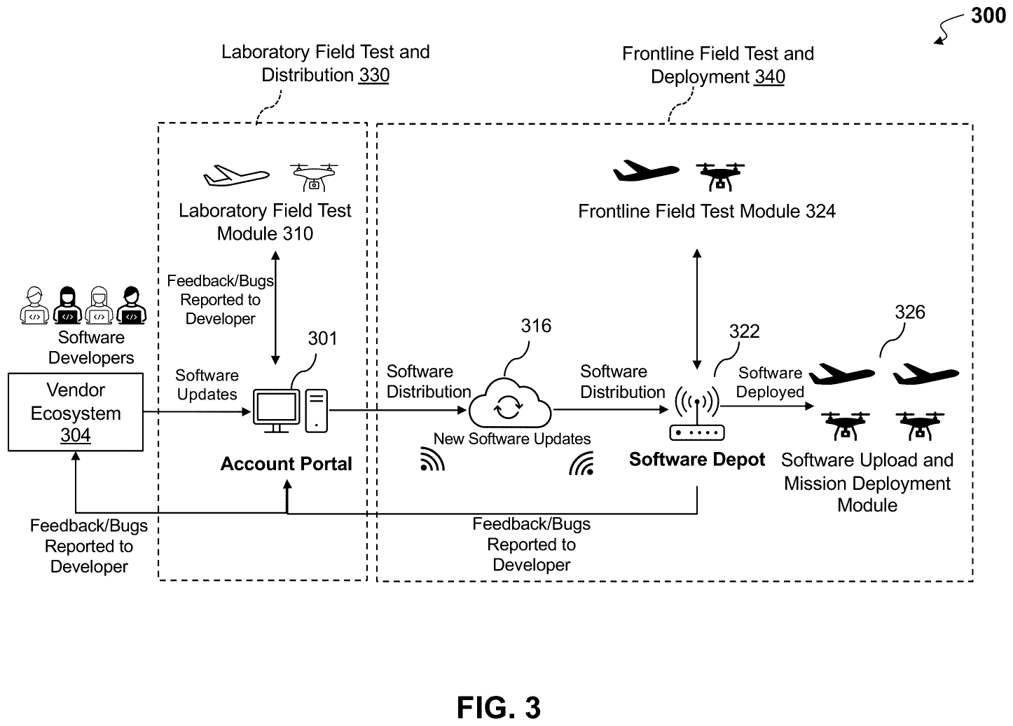

FIG. 3 depicts a depot management system 300 including a frontline software distribution and verification depot, according to one embodiment. The depot management system 300 may allow for a rapid, improved frontline software deployment based on software/update development, laboratory field test, controlled distribution, frontline field test for certification/verification, and iteration of these processes, through a single system.

Referring to FIG. 3, the depot management system 300 may include a laboratory field testing and distribution portion 330 and a frontline field testing and deployment portion 340. The laboratory field testing and distribution portion 330 may include an account portal 301 and a laboratory field test 310, and the frontline field testing and deployment portion 340 may include a server 316, a software depot 322, a frontline field test module 324, and a mission deployment module 326.

Software developers in a vendor ecosystem 304 may provide new software and/or new software updates through the account portal 301. When the new software updates become available, it may require laboratory testing through the laboratory field test 310. In some embodiments, the laboratory field test module 310 may include hardware, software, firmware simulation and field test. As part of system performance analytics, any feedback and/or bugs in the new software updates may be reported to the developer in the vendor ecosystem 304 from the laboratory field test module 310. Specifically, the account portal 301 may receive reports of any feedback and/or bugs while the account portal 301 is in communication with the laboratory field test module 310, such as hardware/software/firmware simulation and field test. The account portal 301 may also be in communication with software developers in the vendor ecosystem 304, and the feedback and/or bugs may be reported to these software developers.

If the new software updates pass the laboratory testing, the lab tested software may be distributed to the frontline field test and deployment portion 340 through a server 316. The software depot 322 may receive the lab tested software through the server 316 and transmit to the frontline field test module 324 for software verification and certification. In some embodiments, the frontline field test module 324 may utilize a frontline field test software but is not limited thereto. The frontline field test module 324 may use a test device, for example, a UAV, for software verification and certification. If any feedback and/or bugs are found during the frontline field testing, that information may be transmitted to the software depot 322 and reported to the developer in the vendor ecosystem 304 via the account portal 301. If the software updates pass the frontline field testing for verification and certification, these certified software updates may become available and ready for frontline field deployment. In some embodiments, the frontline field test module 324 may have Safety Integrity Level (SIL) verification capabilities. In some embodiments, the frontline field test module 324 may include frontline field test software for verification/certification, and the software depot 322 may be in communication with frontline field test software for verification/certification. Once the software is verified and certified, it may be deployed through the mission deployment module 326. The certified software may be uploaded to one or more devices (e.g., aerial vehicles) for mission deployment.

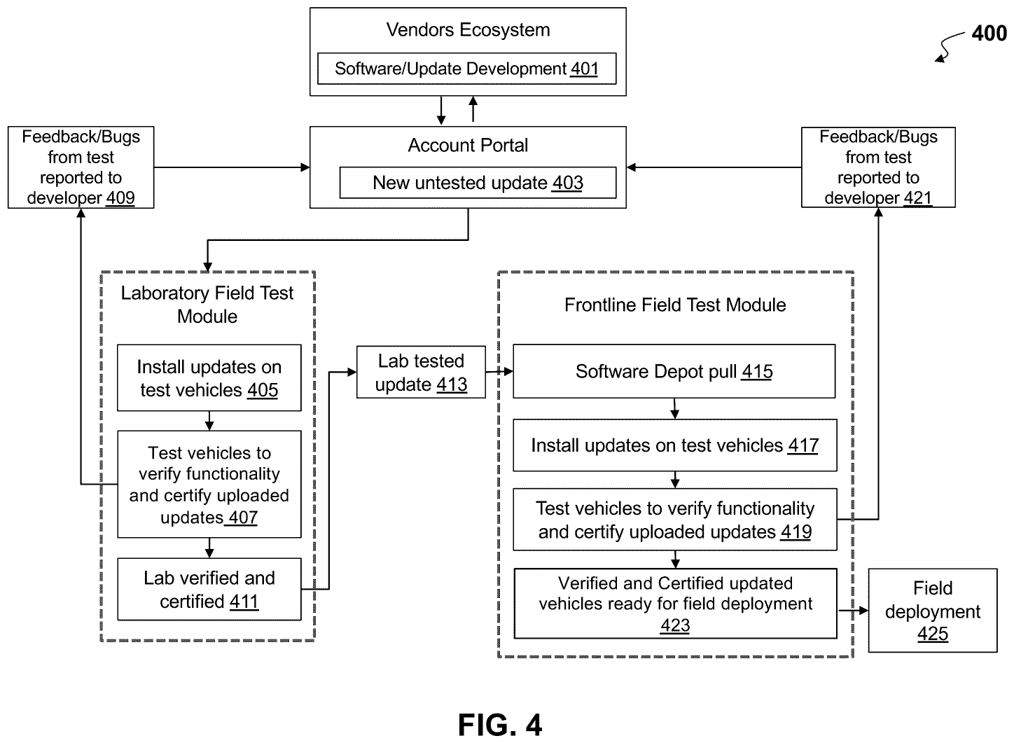

FIG. 4 depicts a depot management method 400 for a frontline software distribution and verification depot, according to one embodiment. The method 400 may begin with software and/or update development by software developers from a vendors ecosystem (step 401). The new untested software and/or update provided by the developers may be available on an account portal for Software-in-the-loop (SIL), Hardware-in-the-loop (HIL), and/or laboratory field testing (step 403). Before an organization rolls out the software and/or update to all the devices/vehicles at the depot, they may want to validate it on their test vehicle. The test vehicle in field may be a slight variant of in-factor as the organization may have done targeted patches instead of all patches. For laboratory field testing, the untested software and/or updates may be installed on test devices (e.g., test vehicles, such as aerial vehicles) (step 405). In some embodiments, the aerial vehicles may be unmanned aerial vehicles (UAVs). The test devices may verify the functionality and certify uploaded software and/or updates (step 407). If bugs are determined to be in the new untested software and/or update, the bugs from the laboratory field test may be reported to the developer of the software (step 409). The report on the bugs may be available to view in the account portal. In response to the reported bugs, additional software development may be conducted to correct any bugs and generate a new untested update for SIL, HIL, and/or laboratory field testing. If bugs are not reported, the software may be lab verified and certified (step 411). In some embodiments, this lab verified and certified software may be ready for deployment.

The lab tested software and/or update may be ready for frontline field testing for software verification and certification (e.g., forward operating base field verification and certification) and transmitted to a software depot for the frontline field testing (step 413). The lab tested software and/or update may be available via a software depot pull (step 415). The software and/or updates may be installed on test vehicles (step 417). The test vehicles may verify the functionality of the installed software update and certify uploaded software and/or updates (step 419). If bugs are found in the software, the bugs from the frontline field test may be reported to the developer (step 421). These bugs may be available to view in the account portal. In response to the reported bugs, additional software development may occur, and a new untested update may proceed with SIL, HIL, laboratory field testing, and/or frontline field testing. If bugs are not reported from the frontline field test, then the verified and certified updated devices with the certified software and/or update may be ready for field deployment (step 423), and then the verified and certified updated devices may be deployed on actual devices for a mission (step 425).

In one embodiment, the test vehicle in the field may be a slight variant of in-factor as customers may have done targeted patches instead of all patched. Before the customer rolls out the update to all the vehicles at the Depot, the system may validate it on the customer's test vehicle. In one embodiment, the list of the tests to run on SIL and HIL to certify may be decided by a software certification group or similar authority of the organization. That is, this system and method decouple the certification authority from certification activity and hence enable rapid deployment of software and/or updates on devices.

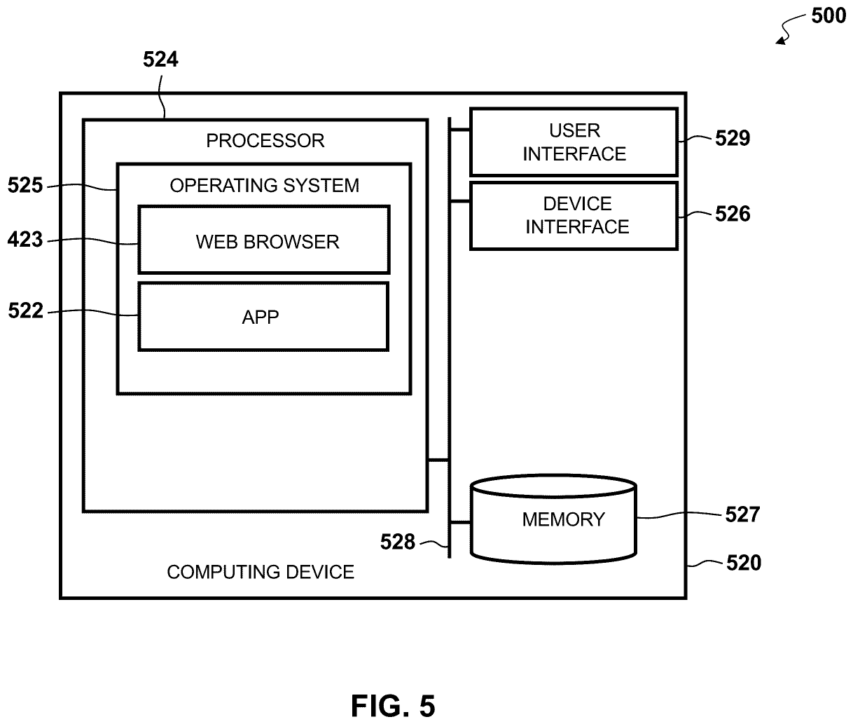

FIG. 5 illustrates an example of a top-level functional block diagram of a computing device embodiment 500. The example operating environment is shown as a computing device 520 comprising a processor 524, such as a central processing unit (CPU), addressable memory 527, an external device interface 526, e.g., an optional universal serial bus port and related processing, and/or an Ethernet port and related processing, and an optional user interface 529, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 528. In some embodiments, via an operating system 525 such as one supporting a web browser 523 and applications 522, the processor 524 may be configured to execute steps of a process establishing a communication channel and processing according to the embodiments described above.

System embodiments include computing devices such as a server computing device, a buyer computing device, and a seller computing device, each comprising a processor and addressable memory and in electronic communication with each other. The embodiments provide a server computing device that may be configured to: register one or more buyer computing devices and associate each buyer computing device with a buyer profile; register one or more seller computing devices and associate each seller computing device with a seller profile; determine search results of one or more registered buyer computing devices matching one or more buyer criteria via a seller search component. The service computing device may then transmit a message from the registered seller computing device to a registered buyer computing device from the determined search results and provide access to the registered buyer computing device of a property from the one or more properties of the registered seller via a remote access component based on the transmitted message and the associated buyer computing device; and track movement of the registered buyer computing device in the accessed property via a viewer tracking component. Accordingly, the system may facilitate the tracking of buyers by the system and sellers once they are on the property and aid in the seller's search for finding buyers for their property. The figures described below provide more details about the implementation of the devices and how they may interact with each other using the disclosed technology.

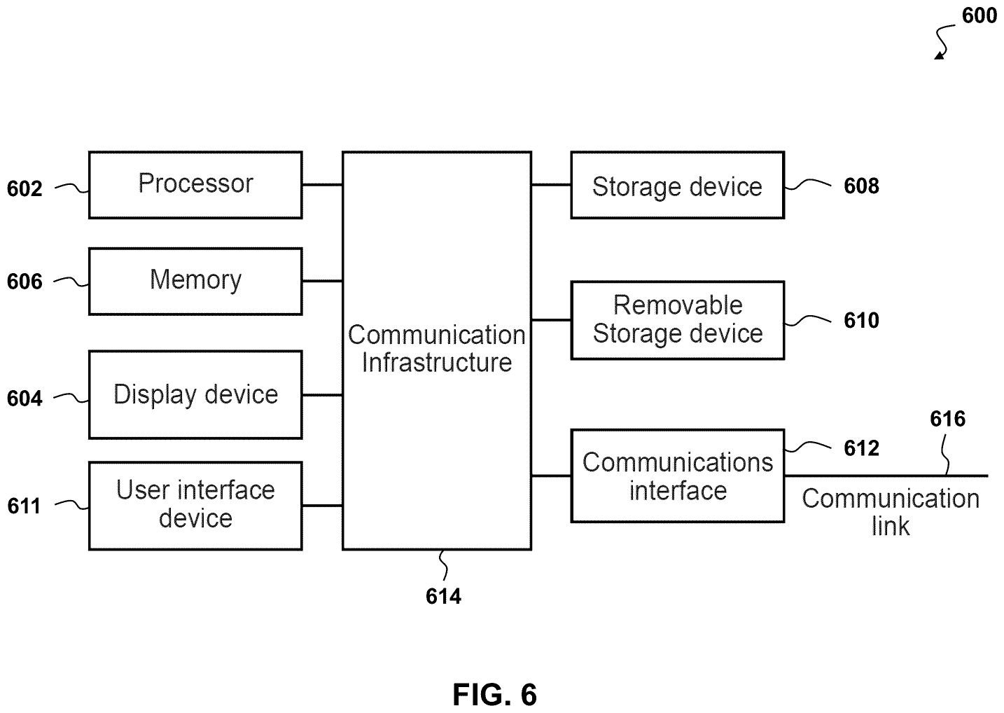

FIG. 6 is a high-level block diagram 600 showing a computing system comprising a computer system useful for implementing an embodiment of the system and process, disclosed herein. Embodiments of the system may be implemented in different computing environments. The computer system includes one or more processors 602, and can further include an electronic display device 604 (e.g., for displaying graphics, text, and other data), a main memory 606 (e.g., random access memory (RAM)), storage device 608, a removable storage device 610 (e.g., removable storage drive, a removable memory module, a magnetic tape drive, an optical disk drive, a computer readable medium having stored therein computer software and/or data), user interface device 611 (e.g., keyboard, touch screen, keypad, pointing device), and a communication interface 612 (e.g., modem, a network interface (such as an Ethernet card), a communications port, or a PCMCIA slot and card). The communication interface 612 allows software and data to be transferred between the computer system and external devices. The system further includes a communications infrastructure 614 (e.g., a communications bus, cross-over bar, or network) to which the aforementioned devices/modules are connected as shown.

Information transferred via communications interface 614 may be in the form of signals such as electronic, electromagnetic, optical, or other signals capable of being received by communications interface 614, via a communication link 616 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 612. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

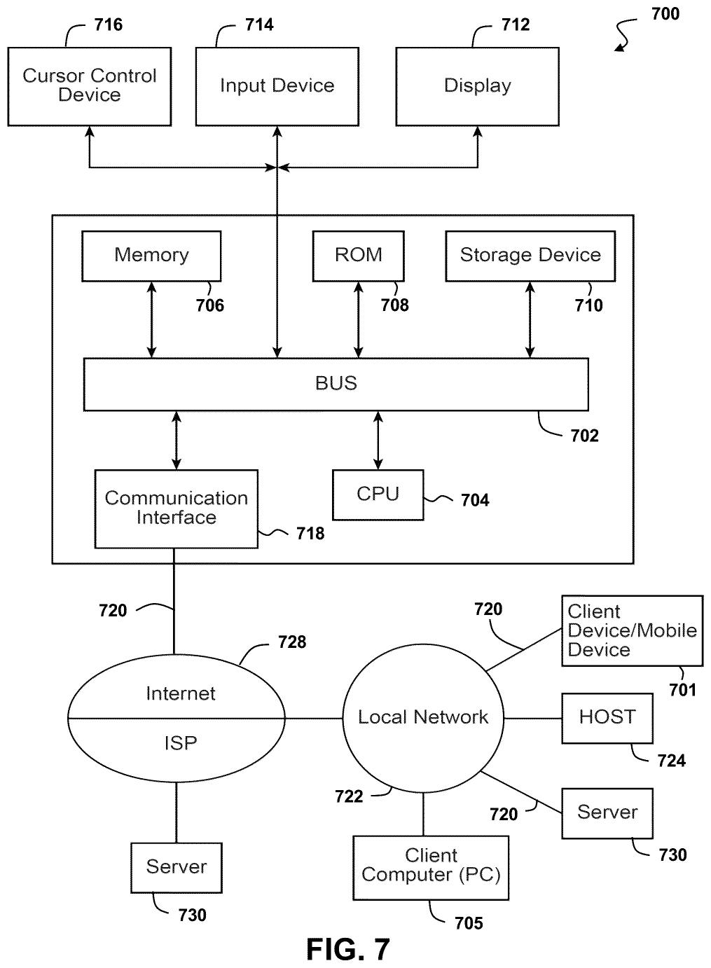

FIG. 7 shows a block diagram of an example system 700 in which an embodiment may be implemented. The system 700 includes one or more client devices 701 such as consumer electronics devices, connected to one or more server computing systems 730. A server 730 includes a bus 702 or other communication mechanism for communicating information, and a processor (CPU) 704 coupled with the bus 702 for processing information. The server 730 also includes a main memory 706, such as a random access memory (RAM) or other dynamic storage device, coupled to the bus 702 for storing information and instructions to be executed by the processor 704. The main memory 706 also may be used for storing temporary variables or other intermediate information during execution or instructions to be executed by the processor 704. The server computer system 730 further includes a read only memory (ROM) 708 or other static storage device coupled to the bus 702 for storing static information and instructions for the processor 704. A storage device 710, such as a magnetic disk or optical disk, is provided and coupled to the bus 702 for storing information and instructions. The bus 702 may contain, for example, thirty-two address lines for addressing video memory or main memory 706. The bus 702 can also include, for example, a 32-bit data bus for transferring data between and among the components, such as the CPU 704, the main memory 706, video memory and the storage 710. Alternatively, multiplex data/address lines may be used instead of separate data and address lines.

The server 730 may be coupled via the bus 702 to a display 712 for displaying information to a computer user. An input device 714, including alphanumeric and other keys, is coupled to the bus 702 for communicating information and command selections to the processor 704. Another type or user input device comprises cursor control 716, such as a mouse, a trackball, or cursor direction keys for communicating direction information and command selections to the processor 704 and for controlling cursor movement on the display 712.

According to one embodiment, the functions are performed by the processor 704 executing one or more sequences of one or more instructions contained in the main memory 706. Such instructions may be read into the main memory 706 from another computer-readable medium, such as the storage device 710. Execution of the sequences of instructions contained in the main memory 706 causes the processor 704 to perform the process steps described herein. One or more processors in a multi-processing arrangement may also be employed to execute the sequences of instructions contained in the main memory 706. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 704 for execution. Such a medium may take many forms, including but not limited to, non-volatile media, volatile media, and transmission media. Non-volatile media includes, for example, optical or magnetic disks, such as the storage device 710. Volatile media includes dynamic memory, such as the main memory 706. Transmission media includes coaxial cables, copper wire and fiber optics, including the wires that comprise the bus 702. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 704 for execution. For example, the instructions may initially be carried on a magnetic disk of a remote computer. The remote computer can load the instructions into its dynamic memory and send the instructions over a telephone line using a modem. A modem local to the server 730 can receive the data on the telephone line and use an infrared transmitter to convert the data to an infrared signal. An infrared detector coupled to the bus 702 can receive the data carried in the infrared signal and place the data on the bus 702. The bus 702 carries the data to the main memory 706, from which the processor 704 retrieves and executes the instructions. The instructions received from the main memory 706 may optionally be stored on the storage device 710 either before or after execution by the processor 704.

The server 730 also includes a communication interface 718 coupled to the bus 702. The communication interface 718 provides a two-way data communication coupling to a network link 720 that is connected to the world wide packet data communication network now commonly referred to as the Internet 728. The Internet 728 uses electrical, electromagnetic or optical signals that carry digital data streams. The signals through the various networks and the signals on the network link 720 and through the communication interface 718, which carry the digital data to and from the server 730, are exemplary forms or carrier waves transporting the information.

In another embodiment of the server 730, interface 718 is connected to a network 722 via a communication link 720. For example, the communication interface 718 may be an integrated services digital network (ISDN) card or a modem to provide a data communication connection to a corresponding type of telephone line, which can comprise part of the network link 720. As another example, the communication interface 718 may be a local area network (LAN) card to provide a data communication connection to a compatible LAN. Wireless links may also be implemented. In any such implementation, the communication interface 718 sends and receives electrical electromagnetic or optical signals that carry digital data streams representing various types of information.

The network link 720 typically provides data communication through one or more networks to other data devices. For example, the network link 720 may provide a connection through the local network 722 to a host computer 724 or to data equipment operated by an Internet Service Provider (ISP). The ISP in turn provides data communication services through the Internet 728. The local network 722 and the Internet 728 both use electrical, electromagnetic or optical signals that carry digital data streams. The signals through the various networks and the signals on the network link 720 and through the communication interface 718, which carry the digital data to and from the server 730, are exemplary forms or carrier waves transporting the information.

The server 730 can send/receive messages and data, including e-mail, program code, through the network, the network link 720 and the communication interface 718. Further, the communication interface 718 can comprise a USB/Tuner and the network link 720 may be an antenna or cable for connecting the server 730 to a cable provider, satellite provider or other terrestrial transmission system for receiving messages, data and program code from another source.

The example versions of the embodiments described herein may be implemented as logical operations in a distributed processing system such as the system 700 including the servers 730. The logical operations of the embodiments may be implemented as a sequence of steps executing in the server 730, and as interconnected machine modules within the system 700. The implementation is a matter of choice and can depend on performance of the system 700 implementing the embodiments. As such, the logical operations constituting said example versions of the embodiments are referred to for e.g., as operations, steps or modules.

Similar to a server 730 described above, a client device 701 can include a processor, memory, storage device, display, input device and communication interface (e.g., e-mail interface) for connecting the client device to the Internet 728, the ISP, or LAN 722, for communication with the servers 730. The system 700 can further include computers (e.g., personal computers, computing nodes) 705 operating in the same manner as client devices 701, where a user can utilize one or more computers 705 to manage data in the server 730.

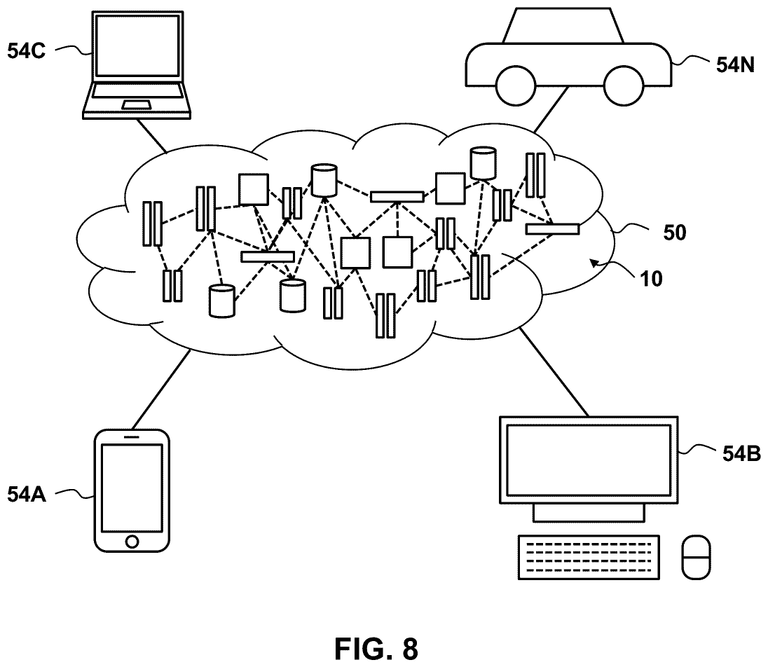

Referring now to FIG. 8, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 8 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a vendors ecosystem including at least one external software developer;
an account portal; and
an end user operation system;
wherein the vendors ecosystem is configured to provide a software component;
wherein the account portal is configured to:
determine an existence of any issues based on whether the provided software component passes a laboratory field test;
report any issues from the laboratory field test to the at least one external software developer;
receive an updated software component from the at least one external software developer fixing the reported issues; and
release the software component if no issues are found indicated that the test was passed;
wherein the end user operation system is configured to:
determine an existence of any issues based on whether the released software component passes a frontline field test to certify the software component;
report any issues from the frontline field test to the external software developer; and
deploy the certified software component on one or more devices if no issues from the frontline field test are found; and
wherein the system is configured to iterate the report of issues, the laboratory field test, and the frontline field test for the one or more devices.

2. The system of claim 1, wherein the software component includes at least one of a software and a software update.

3. The system of claim 1, wherein the account portal includes a software and/or update request system configured to request the software component to the at least one external software developer in the vendors ecosystem.

4. The system of claim 3, wherein the issues found during the laboratory field test and the frontline field test are configured to be reported to the at least one external software developer via the software and/or update request system of the account portal.

5. The system of claim 1, wherein the account portal includes a software factory configured to receive the software component from the vendors ecosystem, and wherein the software factory comprises:
a laboratory field test module configured to perform the laboratory field test; and
a software release module configured to release the test passed software component to the end user operation system based on a predetermined schedule.

6. The system of claim 1, wherein each of the laboratory field test and the frontline field test are configured to be performed using at least one of: a simulation and a test device.

7. The system of claim 1, wherein the end user operation system includes a software depot comprising:
a frontline field test module configured to perform the frontline field test; and
a mission deployment module configured to deploy the certified software component on the one or more devices for mission deployment.

8. The system of claim 7, wherein the end user operation system further includes:
a server in communication with the account portal and the software depot;
wherein the server includes at least one of: a cloud server and an on-premises server.

9. The system of claim 7, wherein the software depot further includes a simulation module to train users of the devices.

10. A method comprising:
receiving, by an account portal, a software component from at least one external software developer in a vendors ecosystem;
determining, by the account portal, whether the provided software component passes a laboratory field test;
reporting, by the account portal, issues found in the laboratory field test to the at least one external software developer;
releasing, by the account portal, the test passed software component to an end user operation system, if no issues are found in the laboratory field test;
determining, by the end user operation system, whether the released software component passes a frontline field test to certify the software component;
reporting, by the end user operation system, issues found in the frontline field test to the at least one external software developer; and
deploying, by the end user operation system, the certified software component on one or more devices if no issues are found in the frontline field test.

11. The method of claim 10, wherein the step for receiving software component includes receiving an updated software component fixing the issues from the at least one external software developer.

12. The method of claim 10, wherein the method iterates the steps for receiving the software component, the laboratory field test, reporting issues found in the laboratory field test, the frontline field test, reporting issues found in the frontline field test, and deploying the certified software component to maintain the one or more devices.

13. The method of claim 10, wherein the step for reporting the issues found during the laboratory field test, the frontline field test, and deployment are performed via a software and/or update request system of the account portal.

14. The method of claim 10, wherein the step for releasing the test passed software component is performed based on a schedule predetermined by an operator of the account portal.

15. The method of claim 10, wherein each of the laboratory field test and the frontline field test are performed using at least one of: a simulation and a test device.

16. A method comprising:
performing, by an account portal, a laboratory field test on a new untested update using one or more test vehicles;
generating, by the account portal, a report of any bugs discovered during the laboratory field test verifying the functionality of the new untested update;
verifying and certifying, by the account portal, the new untested update as a lab tested update if no bugs are discovered during verifying the functionality of the new untested update;
transmitting, by the account portal, the lab tested update to a software depot;
performing, by the software depot, a frontline field test on the lab tested update using one or more test vehicles;
generating, by the software depot, a report of any bugs discovered during the frontline field test verifying the functionality of the installed lab tested update;
verifying, by the software depot, the lab tested update as ready for field deployment if no bugs are discovered during the frontline field test; and
loading the verified lab tested software on devices and to be ready for deployment.

17. The method of claim 16, wherein the step for performing a laboratory field test includes:
installing the new untested update on the one or more test vehicles; and
verifying a functionality of the new untested update on the one or more test vehicles.

18. The method of claim 16, wherein the step for performing a frontline field test includes:
installing the lab tested update on one or more test vehicles via the software depot; and
verifying functionality of the installed lab tested update on the one or more test vehicles.

19. The method of claim 16, wherein the step for sending the lab tested update is performed based on a schedule predetermined by an operator of the account portal.

20. The method of claim 16, wherein the method iterates the steps for performing the laboratory field test, generating the report of any bugs discovered during the laboratory field test, verifying and certifying as the lab tested update, sending the lab tested update, performing the frontline field test, generating the report of any bugs discovered during the frontline field test, verifying and certifying the lab tested update, and deploying the verified lab tested software to maintain the devices.
